(19) United States
(12) Patent Application Publication
(10) Pub. No.: US 2004/0011299 A1
(43) Pub. Date: Jan. 22, 2004

(54) Interactive toy for cats and other prey oriented animals

(76) Inventor: Kimberly Adams Lamson-Scribner, Palisade, CO (US)

Correspondence Address: The Law Office of Craig W. Barber, PO Box 16220, Golden, CO, 80402-6004, US

(21) Appl. No.: 10/624,874

(22) Filed: Jul. 22, 2003

Related U.S. Application Data
(60) Provisional application No. 60/397,666, filed on Jul. 22, 2002.

(51) Int. Cl. A01K 29/00

(52) U.S. Cl. 119/708

(57) ABSTRACT

A solo-interactive animal toy invention comprised of multiple-aspected instinctual attractants. An openwork mobile structure comprised of freely moving rods and plural toys which may be suspended at a level to which an animal ascends for accessible play. Intentional or happenstance action on any part activates transmission of motion through individual parts and the three-dimensional whole, enacting various complex and simple movement styles and formations attractive to a cat. Movements of individual toy-attractants occur simultaneously with overall movement of extended aerial form. When activated, different styles of movement alternate with self-perpetuating rotations. Alternating overlapping pathways among attractants/toys provide for reflex and choice by the cat as to which prey to pursue and when. This cat or other animal toy provides for enduring interest and play. It provides physical exercise and use of instinctual problem solving. It is convenient to humans in various circumstances and environmentally friendly.

### CROSS-REFERENCE TO RELATED APPLICATIONS

The present application claims the benefit and priority of U.S. Provisional Application No. 60/397,666 filed Jul. 22, 2002 in the name of Kim Lamson-Scribner and entitled INTERACTIVE TOY FOR CATS AND OTHER PREY ORIENTED ANIMALS.

### STATEMENT REGARDING FEDERALLY FUNDED RESEARCH

This invention was not made under contract with an agency of the US Government, nor by any agency of the US Government.

### FIELD OF INVENTION

The present invention relates to an interactive toy for cats and other animals. More specifically, it relates to a suspended kinetic mechanism structured in an openwork mobile form.

### BACKGROUND

Description of Prior Art

The present animal toy invention contains overlapping, multi-aspected pathways of movement and multi-aspected instinctual triggers. It provides variety in intensity and type of movement within individual parts and as a whole. This toy provides plural freely moving rods, from which plural attractant-toys are suspended, of which only some attractant-toys are accessible at any one time. It is easily installed, owner friendly and environmentally friendly. The prior art will now be discussed.

Numerous approaches have been taken in making toys aimed toward providing an instinctively fun means of entertaining, exercising and occupying a cat. These have been variously successful in involving the cat's initial or continued attention. Prior art related to cat toys has included toys which are solo-interactive and/or interactive between care provider and cat. Toys have been made which have been dependent on energy derived from technologically advanced sources as well as toys which are free of this dependency. There is abundant prior art in suspended cat toys intending to activate instincts by movement of attractant-toys within a space specific to that toy.

Some prior art in the field of cat toys has been concerned with the awkwardness of floor toys. Cat toys on the floor can be easily lost as well as be tripped over by humans. Some prior art has addressed improving aspects of cat toys in the interest of safety and convenience for cohabiting humans. Prior art which has included the instinct for climbing has typically been oriented toward constructed cat furniture. These constructions may contain toys attached to and within the furniture's environment. These suspended toys typically contain a limited range of movement and stimulus.

There has been established in prior art a climbing system of individually installed shelves, staggered diagonally upward along a wall, with toys accessible for play dangling from beneath each next upward shelf, intended for the pleasure of cats. This “Wall Shelf Amusement Device,” U.S. Pat. No. 6,196,139, invented by Jensen, dated August 1999, addresses a feline instinct to climb higher into the upper space levels of a room, as well as providing dangling toys for play. It is installed along an expanse of wall space and thereby takes up no ground space. Comparatively, the present invention is of lightweight open frame, with much greater variance in types and intensities of motion, with multiple dangling toy-attractants, having changing relationships with each other and moving in overlapping pathways. The present invention requires comparatively little expense in manufacture and shipping, involves less space usage and bulk, and requires little effort for installation.

There has been established in prior art a martial arts practice device, U.S. Pat. No. 5,183,451, invented by Hautamaki, and dated October 1991, which is composed of multiple moving targets which react to a human user striking a target with hand or foot. This device provides choice of target for interaction and a somewhat pre-determined use of reflexes. The present invention is catered to cats or other animals rather than humans, involves complex movement of targets, is aerially placed, of open framework and minimal bulk, and fits in almost any indoor environment relatively unobtrusively, if not pleasantly.

There has been established in prior art a mobile toy for kitten or similar animal, U.S. Pat. No. 4,438,727, (equivalent patents EP098878, WO8302542, JP58501937T, CA1207148) invented by Thompson and dated January 1982. The purpose of the mobile structure in this prior art toy is to facilitate a bobbing movement alongside any swing natural to a singular dangling object when interacted with. This prior art does not take advantage of multiple bobbing motions among multiple toys created when tugging on a reflexively chosen attractor-toy. Nor does this prior art mobile set off multiple rotational and other movements on multiple cat-attractant tiers. It does not create a sense of an overall larger shape of movement of which only parts are accessible for instinctual interaction at any one time. It does not give a sense of presence of a cluster of individually moving prey. This prior art toy is limited to singular-toy movement and singular shapes of movement as compared to the present invention. This prior art mobile for cats or similar animals enacts different intentions and does not aim to fulfill the multiple-aspected attractants and motion forms as contained in the present invention. The present invention contains challenge with characteristically varied accessibility to cat toys while in motion or at rest. In the prior art mobile for cats there is no direct cat-attractant use made of its relatively distantly located and intentionally skewed tiers from which the singular toy dangles, whereas the present invention uses activity inclusive of all tiers in enhancing inviting cat-attractant activity. The prior art interactive cat toy, structured in a mobile formation and with an attached dangling toy toward ground level, is hung from the top of a door frame. This location is more likely awkward for daily human activities as well as care provider viewing. Though dependent on what sort of doorway it is placed in, it is likely it hasn't the same potential for happenstance activation through interior air flows as the present invention. It is catered to ground level play, where the present animal toy invention is preferred to be located in otherwise unused space located in upper levels within a room. The present toy invention differs from this prior art in its differently conceived aims and embodiment, thereby making use of unappreciated and not-conceived advantages through new approaches toward use of a mobile structure in a cat toy.

There has been established in prior art a tensioning type physical therapeutical treatment device, U.S. Pat. No. 4,147,344 (also known as D251,690), invented by Lee dated August 1977. This device is intended to inspire the continuing interest and interaction of children needing therapy, that they might reach toward and grasp dangling toy-like elements, thereby enhancing physical therapy treatment. The dangling toys may be moved both in specific location and in a random pattern of motion. This can naturally entice the exercising of hand/eye coordination as well as exercise the muscles by grasping interaction. The toys are suspended from an overhead structure and the overall arm and vertically rising post are solidly attached to a crib or other object. The present invention is not intended for children, makes use of motion in different ways, is of a freely moving open structure, aims toward different instincts and purpose, involves singular suspension, and is differently located for its specific use.

There has been established in prior art an erratic movement tethered ball striking toy, U.S. Pat. No. 3,785,643, invented by Rich dated February 1971. This toy makes use of several balls, one of which may be partially filled with liquid, suspended on a single line. The use of this toy involves direct interaction with the lowest dangling ball. The more highly placed ball, containing liquid, on the same dangling line, facilitates erratic and unpredictable motion in the ball suspended on the same line beneath it; this upper ball is not immediately interacted with. By this method, humans may better challenge their reflexive timing and muscle coordination skills. The present invention is intended for a cat or other prey oriented animal and aimed toward motivating use of their particular instincts. The present invention has more complex movement within an openwork tiered structure. In the present invention, choices between targets on the interactive lowest tier are provided, and more highly-placed tiers of the machine assist not only in lower level action, but also in sensory perception of a larger shape in movement for triggering instinctual attraction.

There has been established in prior art an educational toy for an infant and means for actuation, U.S. Pat. No. 3,564,759, invented by Buttermore, dated December 1968. This suspended, open framework, and freely moving mobile is intended for solo-interaction on a child's part. The child may interact to create movement of the toy, as well as auditory feedback, independently of any outside activating forces. In its preferred embodiment the frame support, from which the mobile is suspended, is attached to a crib. Buttermore's mobile is concerned with involving the attention of, entertaining, and educating an interacting infant. It is intended to help the child to know and develop their awareness of autonomous abilities. In comparison, the present invention is catered to the instincts and reflexes of a prey oriented animal, and takes a multi-aspected approach in sparking play, development, and satisfaction of these instincts. In the present invention, the individual attractant-toys are instinctually-enhanced by movement in the air as a natural environment for attractant-prey, rather than toys simply being in a suspended state to be noticed and reachable. In the present invention of a cat and other prey oriented animal toy, the two elements of the toys and their movement in a natural territory area are coupled into a relationship of greater, more involving instinct-activating affect beyond the elements themselves. The periodically chaotic form of movement of advantage in the present invention would be a disadvantage in Buttermore's toy. Appropriately, a purpose of interaction for the child's mobile weighs more heavily on the side of less physical activity and more intellectually realized satisfaction. In the present invention, while the toy involves some reflexive problem solving activity and provides for paw-imposed action causing satisfying affect, it also invites more full-bodied involvement and varied physical interaction than Buttermore's toy. The present invention makes use of motion in different ways, aims toward different instincts and purpose, and requires different placement for its specific use.

There has been established in prior art an exercising device for birds, U.S. Pat. No. 3,181,504, invented by Stortz dated May 1965. This device aims to provide multiple forms of exercise through variously available activities within one toy. Each component-activity has a different response to the bird's interaction, such as vibration or swinging. One component, when the bird lands on it, enacts a transmission of energy causing movement in another component which, after this other component has completed a specific movement, transmits energy back to the component the bird is sitting on and causes motion for the bird to experience in that component. Stortz's invention is preferably placed outside the bird's cage, where the bird is naturally attracted toward it and can pursue interaction with it. It is designed to provide challenge and maintain lasting interest for the bird, through varieties of motion activated by the bird. It is also designed to be aesthetically and entertainingly appealing for human caregivers. The present invention uses different attractant methods and is directed toward the synthesis of multiple-aspected instincts in a cat or other prey oriented animal. The present invention, preferably reached by climbing or jumping, is interacted with by the cat's paw rather than being activated by a bird alighting upon a part of the device. The present invention is suspended of itself from a higher point, where Stortz's device for birds is secured to a surface with a vertically-rising rod for support. The present invention is entirely composed of parts moving in relationship to each other, and movement of any one part transmits energy through other parts in a more unified movement than is seen in this prior art. In the present invention, the various movements of all individual parts combine into a movement of the device as a whole, rather than specific parts carrying out more clarified types of differentiated movements specific to each part with the overall device itself staying stable. The multiple transmitted movements of the present invention are characteristically different in intent and embodiment and cater to meeting instincts specific to cats and other animals having similar instincts.

There has been established in prior art an amusement device for infants, U.S. Pat. No. 2,303,223, invented by Murray and Murray, dated April 1942. This device transmits movement caused by a baby pulling a teething ring, which by means of a stretching and contracting elastic band causes oscillating movement in an otherwise inaccessible toy frog or other toy. The toy frog maintains a self-perpetuating momentum in motion for a period of time which prompts activation of a noisemaker such as a bell. The support structure for Murray's device spans across and attaches to a crib and can be adapted to attach to other furniture. On initial set-up, the height at which this amusement device rests is adjustable so that the teething ring is reachable to a child in a crib. This toy is responsive to a child's instinctive desire for the teething ring, creating transference of motion to provide multiple amusement levels of both visual and auditory action. The present interactive cat toy invention transmits movement throughout the toy in a way that is not as exclusively limited in particular movement style to that specific element. The present invention provides a broader overall changing shape of prey in relation to each other, and varied stages of movement, including a lateral-momentum stage, alongside unified movement of its parts. The plural instinctually attracting-toys are catered to a cat's instincts for prey. In adjusting the present invention's height on initial set-up, providing for accessibility to the lower tier interactive toys, it is preferably placed in a location where the cat or other animal must physically move by jumping or climbing to reach the accessible attractant-toys. These lower tier toys move in overlapping pathways without coinciding on the same pathway at any one time, thereby providing choice in which accessible attractant-toy to pursue.

There are numerous examples of non-electrical interactive cat toys suspended from a single tether-like string or line ending in a mouse toy or other pet-attractant, which are not connected to a ground-base structure. This type of prior art is usually hung where the suspended end-toy can be reached by the pet while the pet is at ground level. Some of this prior art has been adapted to creating less predictable movement through use of elastic, springs or other adaptions. This type of prior art, with singular suspension means, travels a singular pathway and is suspended from a singular, directionally consistent source element. While suspension from a single line can be adapted to provide erratic motions through a small or broader area of space, the motion induced by the pet is still limited to a somewhat fixed repertoire of singular pathways. However, a singly suspended item is only able to maintain certain variations in movement and momentum, having a range of movement specific to the single toy in its own individually defined target space and in relation to itself. It is characteristic of these sorts of toys that they maintain a stable position when not actively played with. They are typically hung from doorknobs, doorframes, walls, trees, tables, or use some sort of suction cup or wall bracket from which a lone line is suspended, etc. Most of these toys are primarily intended for solo use by the animal. Two of the more pertinent examples of this sort of toy in prior art are U.S. Pat. No. 6,318,300 (Renforth, November 2001, Pet toy: marketed under the name “Swat and Swing” which has varied motion and may be attached to a wall or other surface); and U.S. Pat. No. 5,474,032 (Krietzman, et.al., December 1995, Suspended feline toy and exerciser). This is a popular concept and there are many variations and improvements within its range.

There are numerous examples of singly suspended attractant-toys dangled from an upwardly-extended vertical column attached to a base in prior art. Other than being integrally suspended from a structural element extending from a base, the general characteristics of the suspended toys addressed in the preceding paragraph generally hold true to this category of prior art toys, as well. Additionally, they take up ground space. Two of the more pertinent examples of this type of prior art toy for domesticated animals are: U.S. Pat. No. 4,940,018 (Edling, October 1987, Toy for cats: vertically-supported rod with suspended toy, providing complex and pendulum types of movement); and CA465221 (Ashbaugh, May 1950, Tethering device: flexibly-sectioned vertical pole on stable base having suspended line ending at distal end with toy).

There are numerous examples of singly suspended toys operated by humans which are intended for interaction between care provider and pet. Through the actions of the care provider, movements in attractant-toys can be provided with more unpredictability. This type of toy provides for flexibility in location of interaction, determined by the movement of the care provider. They employ singular-end attractants, require care provider interaction, and are most often used for approach at ground level, though this last feature is flexible. While their movement can be enhanced in complexity through the caretaker's actions, this type of prior art is still limited to the animal following and playing with a singular end attractant. A pertinent example of prior art in this area is the “Whirly-Bird Cat Exercise Toy” (a bamboo wand toy suspending a singular feathered toy, which toy mimics the look, movement and sound of a bird, at the distal end of line) which was copyrighted in 1997 and is sold by Aeries Enterprises, through www.whirly-bird.com over the Internet. In the present toy invention, caregivers needn't be available for interaction, or be concerned with their energy ebbing before the cat's interest is fulfilled. The present invention is solo-interactive and naturally involves a cat in its multiple attractants in changing formations, overlapping pathways of decentralized movement, as well as providing choice in alternatingly accessible interactive toys.

Some prior art pet furniture contains dangling toys suspended from parts of a ground-based structure and accessible by climbing. In this type of prior art, the pet enters into either an enclosed space or an integrally implied space of the furniture to reach the toys. Prior art in this category is self-contained and the structures are typically of some bulk and mass. The dangling toys are integrated into a larger structural environment. A pertinent example of this prior art is: U.S. Pat. No. 5,713,306 (Johnson, February 1998, Feline playground system, a floor-to-ceiling structure having mobile-like elements contained within its larger-implied structure). The present invention is independently suspended; installed in a position of owner's choice; of comparatively less cost and bulk; and takes up no ground space.

There are examples in prior art of solidly built constructions from which there are plural toys dangling from a ceiling level component of the toy structure. These contain varying degrees of, and methods for, enacting potential motion. Prior art of this type may also include physically layered levels providing various types of interactive activity by a pet. Two examples in prior art that may be considered pertinent to the present invention are U.S. Pat. No. 6,378,463 (Simmons, April 2002, Interactive pet device: cylindrically structured cat furniture toy containing a lower level with rotatably-suspended toys, a mid-level with circulating ball structure and a top section containing a bed); and U.S. Pat. No. 5,339,770 (Haffner, August 1994, Exercise and amusement toy for pets: an umbrella form providing varying types of movement with rotatably suspended toys, the umbrella being supported vertically by a springed stem on stabilizing base). The present invention is suspended in entirety and is of substantially less weight and bulk than prior art in this category. The present invention has an openwork aerial structure manifesting multiple three-dimensional configurations, comprising varying direction among the individual elements, simultaneous with providing overlapping pathways of accessible and inaccessible toy action.

There are numerous cat toys whose aim is to entice cats through motion provided by technologically dependent sources. Some of these have varying speeds at which they can be set, or aspects creating movement at irregular intervals, oscillations, or some other deviation that assists the suspended toy in regular or irregular movements. They are ground or platform based and many involve using an off/on switch, drive members, motors, etc. Prior art in this category directly suspends or has arm extensions from which a target toy dangles. They necessitate the use of technology such as electricity, microchips, batteries, etc. Some have motion detectors and/or are audio-capable for making “prey” sounds, activating when they are turned on. They have relatively complex inner workings contained within various types of casings. Some pertinent examples of these are: U.S. Pat. No. 6,360,694 (equivalent to US20020020362)(Noto, February 2002, Toy for animals: rotating unit providing for some chaotic movement of toy); U.S. Pat. No. 5,675,225 (Moore, Wilson, and Lynn, August 1995, Interactive pet toy: directly improving on Moore, et.al.'s previous Frequency controlled oscillating pet toy, patented under U.S. Pat. No. 5,119,001, June 1992); U.S. Pat. No. 5,103,770 (Berkovich, April 1982, Pet exercising device); and U.S. Pat. No. 4,930,448 (Robinson, June 1990, Animal toy). Additionally, the “Flying Bird Cat Toy” (ground-based pedestal with battery operated rotating arm suspending a bird-like toy) is available from PetMarket.com. This type of prior art involves use of more environmentally complex resources and creates different sorts of toy motion in space than the present invention. This prior art has motion of the toy necessarily connected to a casing of some sort which is dependent on activation by induced technological means. The present invention is environmentally friendly in its simplicity; provides complex, multi-directional, and crossing pathways of elements and multiple toys; contains natural evolvements and disturbances in a series of characteristic movement patterns; has motion more flexibly responsive to the animal; and takes advantageous use of a structure which enhances natural means for transmitting energy through its elements, as well as furthering self-perpetuating rotations for a period of time in a balanced movement state. The present toy is aerially placed and lightweight in overall sensation.

There are a number of magnetically activated pendulum systems in prior art which include suspended objects transmitting energy from one part to another to cause motion. These magnetically kinetic devices use a natural source of energy transmission in activating motion in a suspended object or multiple-suspended objects. This motion can include arrhythmical deviations and rotations which then settle toward more regulated movements. A pertinent example of prior art for human amusement in this area is: U.S. Pat. No. 4,011,674 (Jacobsen, March 1977, Magnetic kinetic amusement devices: this device contains multiple pendulums activated to motion by magnetically-sourced transmissions). The present invention is directed toward instincts and reflexes of prey oriented animals, advantageous use of naturally-sourced energies not including magnetic sources, contains different forms of and pathways of movement, employs multiple suspended attractant-toys, and is aerially suspended.

Mobiles for infant stimulation and human entertainment are well established in prior art. There are numerous approaches to mobile construction including being motorized, having activating timers, having winding devices, being activated by air flow, being of variously open or closed structure, and musical activation simultaneous to movement. Prior art in this area includes various intentions for mobile use including being visually entertaining, human interactive, and/or having purposeful storage and/or display function. Prior art mobiles have been hung from varying locations including cribs or ceilings. Mobiles intended for infants and small children, for entertainment and developmental reasons, are typically attached to a crib or chair and have interactively accessible or sensory stimulating suspended items of particular interest to children. These mobiles provide entertainment and an exploratory learning function for the child's development. Mobiles in prior art generally accommodate gentler, slower, more consistent rotations of movement. An exception to this can be found in a previously examined example of prior art, the “mobile toy for kitten or similar animal” which is stated in its description to be adaptable to the use of children, and which intentionally exploits the bobbing of a singular toy created by a skewed mobile mechanism hung from a doorway. Examples of prior art in the area of mobiles which may be seen as pertinent to the present invention are U.S. Pat. No. 5,393,075 (Harber, February 1995, Mobile); U.S. Pat. No. 4,214,808 (Hampson, July 1980, Kaleidoscopic mobile); U.S. Pat. No. 3,290,817 (Stanley, December 1966, Mobile toy: for children's visual entertainment, having suspended birds with built-in mechanism allowing wings to flap); U.S. Pat. No. 2,828,963 (Steiner, April 1958, Chiming toy: dual sensory interest for child in multiply-tiered mobile); and U.S. Pat. No. 810,900 (no inventor or date cited, unnamed: interactive mobile extending over chair to area accessible to seated baby).

In the construction of the present invention, a structural skeleton of mobile form provides a foundational multiple-form movement feature enhancing achievement of its aim and purpose. The present cat or other animal toy invention makes use of the sensitivity to movement and three-dimensional forms which an openwork mobile structure can provide. The present animal toy invention combines an enhanced sense of a larger overhead aerial movement form with multi-aspected triggers specific to an animal's instincts and reflexes. Movements in the present invention range from chaotically bouncing rotations, to further variances in unpredictably activated motion formations of instinct triggering toy relationships, to the more relaxed and predictable yet still challenging rotations where an attractant-toy is more easily accessible for animal interaction. The present invention provides an intentionally wider range of movement styles than prior art mobiles. The variations of movement in the present cat toy are created by several factors including intensity of aggressive interaction, the momentum riding evolution of movement toward rhythmical rotations of tiers and the whole, and its potential happenstance activation. In the present invention, the chaotic movement stage is desirable, where in many mobiles this type of movement would be considered detrimental to their purpose. An advantage of the chaotic movement stage caused by aggressive cat interaction is providing the interacting animal a perception of having disrupted a nest of prey, sending them scurrying in unpredictable, circular directions. Variations of movement type make available varying degrees of challenge for a cat, while providing a baseline accessible challenge in the slowed momentum stage of movement. In the present invention, interaction with one attractant-toy brings about further opportunities for interaction with other attractant-toys in the airborne environment. In the present invention, reflexive instincts toward prey are channeled into constructive exercise and entertainment. This invention generally differs from prior art mobiles in its animal toy intention, enlivened action and use, various movement stages, multi-dimensional and overlapping instinctual triggering, and in how these parts come together as an instinct and reflex triggering whole.

There is additional prior art which might be considered relevant in the book Feng Shui for You and Your Cat by Alison Daniels, copyrighted 2000 by The Ivy Press Limited, Watson-Guptill Publications, New York. On page 90 of this book is illustrated a ceiling-suspended mobile of fish ornaments with an observing cat sitting on the floor watching from below. This mobile is shown to be in movement by use of directional arrows. The mobile relationship to the cat is one which is described in nearby text as a mobile by which a cat may be entertained. This is quite plainly understood to mean the cat is being exclusively visually entertained.

There exists a continuing need for both newly-conceived and improved cat entertainment and exercise toys which are enduringly involving to the cat, convenient to the cat's caregivers, economical, and environmentally friendly. There is much prior art in the field of suspended cat toys, and cat care provider interest in these is easily noticed in the marketplace. Growing numbers of people include indoor cats as members of their households and, in caring for them or because of busy work schedules, seek means for their exercise and entertainment. Cat caregivers come from varying economic circumstances, including those living in relatively small dwelling spaces. Prior art does not offer an economical, solo-interactive toy of such involving activity, locatable in such conveniently space saving placement, as is seen in this invention.

Prior art does not provide a similarly conceptualized and configured assemblage as is known in the present invention. There is no suspended interactive cat toy providing such varying configurations, utilizing spatial continuity in a plurality of aerially placed and multi-aspected rod and cat toy components, of integrally moving positions, within a three-dimensional construction, similarly responsive to interaction, as in the present invention.

There are no examples meeting, in the same way as the present invention, the multi-aspected instinctual triggers, experiential satisfaction and heightened activity for a cat toy. In prior art, cat exercising and entertainment devices have most typically been confined to using toys, singly suspended, within their own certain space. In fewer cases, multiple objects manifest movement and/or rotation but these individual attractants also move in a more regulated area of defined space. Prior art has not involved a unified yet scattered dancing of toys in varyingly accessible proximity for the animal, in intertwining three-dimensional pathways, as is contained in the present toy invention. Prior art has not provided for interactively-stimulating chaotic motion of multiple elements which then naturally rearrange to more predictable, momentum-maintaining rhythms, thereby allowing for varying degrees of accessible challenge, in the same way. It has failed to take as full advantage of, in the way the present invention does, a combination of multiple movements of plural instinctual attractants, thereby exercising certain focusing abilities of prey oriented animals. Prior art has not accentuated providing reflexive choice in which attractant to pursue, among alternatingly available plural attractant-toys, in the same way as the present invention.

Additionally, there is no prior art that has made use of the doubling over, or overlapping, sense of prey, inclusive of an instinctive perception of a larger aerially animated presence of which only part is accessible as an achievable challenge. Prior art has not addressed chaotic and dancing movements, evolving into rhythmically rotating clusters of plural toys, in the way this invention has. Prior art has tended toward suspended danglers being accessible from ground level or included within the implied space or enclosed structuring of items based at ground level. In the interest of attractant movement or companionable sense of presence, prior art in interactive cat toys has not utilized sensitivity to happenstance or other air energy flows in the same way as the present invention.

No previous art combines the same elements as are seen in the present invention toward achieving the same result. It is differently conceived and manifested as compared to prior art. In the present invention, the combination of various aspects finds result in individual elements creating an affect both inclusive of and greater than the sum of its parts. The present cat invention successfully intrigues and maintains the enduring interest of a cat while meeting convenience needs of caregivers. It substantially meets the needs as posed. There is no prior art meeting the particular spirit of this cat toy invention.

### SUMMARY OF THE INVENTION

General Summary

The present invention is a cat or other prey oriented animal toy providing enduring enjoyment and challenge through instinctual interaction on the animal's part. This primarily solo-interactive cat toy is comprised of three or more suspended rods from which attractant-toys are dangled. It may contain one or more freely moving tier levels while being preferably of a multi-tiered formation. It allows for complex, three-dimensional, overlapping, and varyingly irregular and more regular, patterns of movement. This toy invention supplies, through characteristics contained within its simple structure and features, a toy of multiple instinctual triggers relating to prey oriented animals.

Movement of any one part transmits movement throughout, via the vertical support lines and horizontal tier rods. When activated, transmission of energy through the structure creates and recreates movement in individual parts and the device as a whole. The forms of motion manifest in various stages ranging from chaotic, pivotal, randomly-oscillatory motions among the tiers of suspended toys, to slower and more rhythmic, twirling rotations, all of which may vary directionally within each tier. These movements also include cyclically recurring, non-simultaneous, overlapping pathways of traveling tiers as the entire toy revolves. Amid the variations of movement, this toy intrinsically carries evolutions of movement while maintaining natural momentum for a period of continued movement throughout its freely moving parts and whole.

The present toy provides for a sense of chaotic movement among a cluster of independently airborn, individual, prey-like, attractant-toys in proximal relationship. Additionally, a sense of airborne prey is offered not only through movement in individual toy-attractants, but in movement of the whole, as well. Through one or more tier levels, this toy provides individual target toys directly accessible to interaction as well as a sense of a greater moving body of which only part is accessible to the animal's reach. Thus, it provides a dual and overlapping instinctual sense of animated prey.

This toy invention also carries the characteristic that it may be more quietly activated simply by happenstance air currents initiating gentle rotations of the rods with suspended toy-attractants twirling in its freely moving structure. This gentler activation can attract the cat's attention for play or provide a sense of animate presence within an indoor space.

This animal toy invention allows for directly interactive or passive initiation and reinitiation of various intensities and types of movement. Depending on the force imposed by an intentional contact or happenstance source, the activating or reactivating of the toy sends it into motion that ranges from initially chaotic to more subtly wandering. When the impact is an aggressive batting or tugging of a target toy, the overall toy device responds with its most highly activated stage of movement. This chaotic movement is manifested in seemingly haphazard bouncing and swinging rotations among its various tiers and the toy as a whole. This initially chaotic motion then settles into more balanced rotations of each rod section, alongside calmed activity in the dangling attractant-toys. At this more balanced and rhythmically revolving stage, toys again become more accessible to focused interaction or simpler reflexive action on the cat's part. In this slowed state of movement, tiers maintain momentum in laterally rotating circles.

The present invention is preferably suspended in an upper-room-space location accessible to the animal by climbing or jumping. This toy is designed to playfully exercise and satisfy multi-aspected natural instincts and reflexes, to provide choice in prey or part of prey to pursue, to stimulate an animal's instincts and reflexes both mentally and physically, be an accessible challenge of active and enduring interest, be convenient and pleasant for humans in various dwelling circumstances, and to be powered by interaction and advantageous use of natural laws. It is intended to be a beneficial toy for both cats and their human caregivers.

Summary in Reference to the Claims

It is therefore a first aspect, advantage, embodiment, and objective of the present invention to provide an interactive toy for cats comprising: a plurality of vertically sequential tiers, each tier having at least one beam, the beam being substantially horizontal; each beam of the tiers above the lowest tier having suspended therefrom at least one member selected from the group consisting of: cat attractants, beams and combinations thereof; wherein each of the beams of the lowest tier having suspended therefrom a plurality of cat attractants; whereby contact with one cat attractant causes dynamically linked motions of the beams and the other cat attractants, and contact with one beam causes dynamically linked motions of the beams and other cat attractants.

It is therefore another aspect, advantage, embodiment, and objective of the present invention to provide a cat toy wherein the cat attractants are in visual proximity to each other.

It is therefore yet another aspect, advantage, embodiment, and objective of the present invention to provide a cat toy wherein the cat attractants further comprise simulated prey suspended at least in part by their tails.

It is therefore yet another aspect, advantage, embodiment, and objective of the present invention to provide a cat toy wherein at least one cat attractant further comprises one member selected from the group consisting of: spoons, feathers, fabric strips, balls, metal disks, simulated birds, bells, reflective objects, simulated solitary prey, simulated group prey, lights, hookless fishing lures, pet toys, and combinations thereof.

It is therefore yet another aspect, advantage, embodiment, and objective of the present invention to provide a cat toy further comprising: suspension means for suspending the cat toy from above, the topmost tier being suspended therefrom.

It is therefore yet another aspect, advantage, embodiment, and objective of the present invention to provide a cat toy further comprising: a suspension device, the topmost tier being suspended from the suspension device.

It is therefore yet another aspect, advantage, embodiment, and objective of the present invention to provide a cat toy wherein the suspension device further comprises one member selected from the group consisting of: a hook, an eye-hole screw, a bracket or combinations thereof.

It is therefore yet another aspect, advantage, embodiment, and objective of the present invention to provide a cat toy wherein suspension of the tiers is accomplished by means of one member selected from the group consisting of: strips of fabric, monofilament lines, strings, wires, chains and combinations thereof; wherein such suspension members are strong enough to resist breaking by a prey animal using the cat toy.

It is therefore yet another aspect, advantage, embodiment, and objective of the present invention to provide a cat toy wherein the beams further comprise at least one small notch, and further wherein at least one suspension member wraps around at least one beam at the small notch.

It is therefore yet another aspect, advantage, embodiment, and objective of the present invention to provide a cat toy wherein the suspension members are secured to the beams by means of one member selected from the group consisting of: adhesive, passing through the beams, wrapping around the beams, hooks, swivels, and combinations thereof.

It is therefore yet another aspect, advantage, embodiment, and objective of the present invention to provide a cat toy further comprising: at least one beam end bumper covering a first end of a first beam.

It is therefore yet another aspect, advantage, embodiment, and objective of the present invention to provide a cat toy wherein the beam end bumper further comprises a cat attractant.

It is therefore yet another aspect, advantage, embodiment, and objective of the present invention to provide a cat toy further comprising: beam coating covering at least a portion of the beams.

It is therefore yet another aspect, advantage, embodiment, and objective of the present invention to provide a cat toy wherein the cat toy is suspended substantially above a climbing object suitable for climbing by a prey animal, at a height requiring the prey animal to climb the object in order to play with the cat toy.

It is therefore yet another aspect, advantage, embodiment, and objective of the present invention to provide a cat toy wherein the cat toy is suspended at a height such that the prey animal may reach the cat attractants suspended from the bottom tier when the cat toy is not in motion.

It is therefore yet another aspect, advantage, embodiment, and objective of the present invention to provide an interactive toy for cats, the cat toy being rotatably suspended, the cat toy comprising: a first tier comprising a first beam, the first beam having suspended therefrom at least one additional beam; at least one beam having suspended and balanced therefrom a plurality of suspended cat attractants, wherein the cat attractants are in visual proximity to each other, whereby dynamically linked responsive motions are provided.

It is therefore yet another aspect, advantage, embodiment, and objective of the present invention to provide an improved interactive cat toy, of the suspended type, wherein the improvement comprises: multiple tiers at different levels; a primary axis at the highest tier suspending the remainder of the interactive cat toy; and a multiplicity of cat attractants suspended symmetrically by weight about the axis of suspension and suspended in vertically layered tiers; whereby, a multiplicity of cat attractants are suspended in dynamic linkage with one another in order to simulate flocking behavior of prey.

### BRIEF DESCRIPTION OF THE DRAWINGS

FIG. 1 shows a presently preferred embodiment of the invention in an overall context, illustrating an interacting animal, located in an upper space position within a room, with paw access to rotating lower tier dangling toys.

FIG. 2 illustrates the general elements of a preferred embodiment of the toy in a stasis position.

FIG. 3 illustrates both still and chaotic movement potentials of a preferred embodiment of the toy, with arrows indicating ranges in movement directions and motion shapes.

FIG. 4 illustrates a sectional view of an embodiment of involving line and rod connection, showing a suspension line being run through rods and attractant-toys, as well as illustrating bumpering of rod endings by pom-poms.

FIG. 5 illustrates a sectional view of an alternative embodiment of line and rod connection, showing a suspension line being wrapped around and knotted on a notched rod. This sectional view also includes showing an embodiment of suspension line being partially run through attractant-toys, with capping on one toy, as well as illustrating bumpering of rod endings by wrapping of metallic tape.

FIG. 6 illustrates an alternative embodiment of the invention comprised of three rods and one tier, accessible from commonly owned furniture.

FIG. 7 illustrates an alternative embodiment of the invention including use of feathers and bird toy-attractants, suspended from a bracket hook installed in a wall, interaction being accessible from cat furniture.

### LIST OF REFERENCE NUMBERS UTILIZED IN THE DRAWINGS OF PRESENTLY PREFERRED EMBODIMENT AND BEST MODE NOW CONTEMPLATED FOR CARRYING OUT THE INVENTION

10 Invention as a whole

12 Installation mechanism, such as a nook, for suspending toy in entirety

20 Upper tier, composed of rod and toys

21 Second-down tier, composed of rod and toys

22 Third-down tiers, composed of rods and toys

31 Upper rod

32 Second-down rod

33 Third-down rods

40 Highest level suspension line, of adjustable length, used in connecting entire toy to installation mechanism

41 Suspension line connector between upper and second-down tiers

42 Suspension line connector between second-down tier and third-down tiers

50 Suspension lines dangling from ends of uppermost rod, connecting with toys at distal ends

51 Suspension lines dangling from ends of second-down rod, connecting with toys at distal ends

52 Suspension lines dangling from ends of third-down rods, connecting with toys at distal ends

53 Suspension line dangling from center of second-down rod, connecting with toy at distal end

54 Attractant-toy connection method: reassured by suspension line running through rods and body

55 An alternative attractant-toy connection method: reassured by suspension line connecting in end of toy, with or without reaffirming cap at connection point

60 Bumpering method: fibrous pom poms at rod ends

61 An alternative bumpering method: using metallic tape wrap

62 Reassuring connection: plastic coating at suspension line connection point with rod

63 An alternative reassuring connection: knotting, fusing or other means of securing end of suspension line in position on rod

64 Notch in rod

65 Connection method: suspension lines running through hole located on rod

66 An alternative connection method: suspension line wrapped around rod

70 Wave-form indicating continuance of rod length

72 Wave-form indicating continuance of suspension line length

81 Above-ground level supporting area providing animal access to interactive play

90 Interacting animal

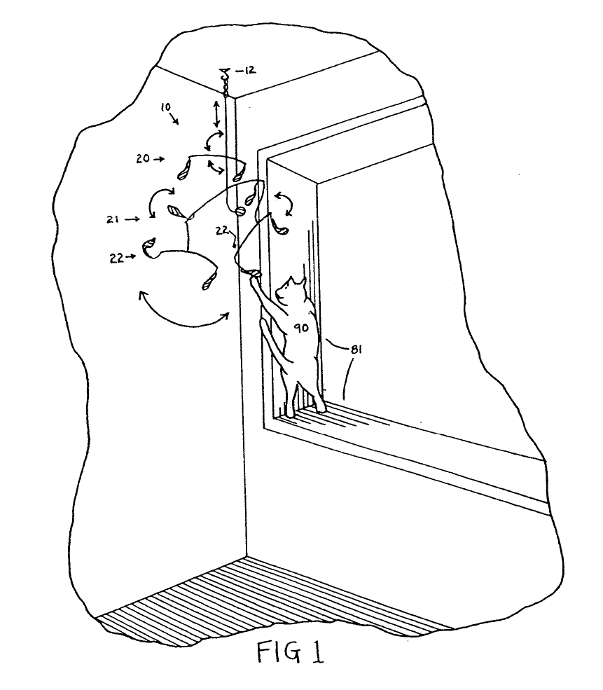

Numbers used repeatedly in diagrams refer to repeated instances of a single component. Numbers having similar two digit endings (Invention 10 in FIG. 1, Invention 710 is FIG. 7) refer to similar parts of differing embodiments.

### DETAILED DESCRIPTION OF THE INVENTION AND FURTHER BACKGROUND OF THE INVENTION

It is an object of this invention to stimulate and provide a primarily solo-interactive activity for cats or other prey oriented animals. Many domestic cats spend the majority of their time indoors. Many cats live exclusively indoors due to safety concerns, city living necessity, preserving wildlife or other reasons. Many caregivers have busy schedules and work many hours away from home while their cat remains home alone. Caregivers, such as some elderly and disabled, also may not be as able to provide enduring mutually-interactive play with their pets.

A cat's prey oriented instincts inspire it to play. Instincts are perked, used, satisfied and then perked again in this toy. Through simulating and maximizing on innately appealing triggers to cats, this toy invites instinctive action. Through its continually changing form, multiple prey, dynamic movement and opportunity for discovery, it holds interactive interest for extended sessions of play as well as maintaining longevity in ongoing interest. It attracts a cat independently of any outside energy source, be it human or technological.

While a cat may pursue this toy because of instinctual attraction, it may also be lured into activity with the toy by noticing the toy's being subtly activated by air currents. If enacted in motion, or brought alive, by these happenstance air currents, this toy may invite interaction or provide a sense of a gently animate presence, serving to keep the cat company in a quiet way. This sense of an airy, fleeting and elusive presence in the house, while ultimately being accessible for play, can be both a comfort and an invitation.

While this toy's aim is to be independently involving to a cat, it can be used in mutually interactive ways with the care provider and cat, if desired. For example, the care provider might trigger movement while the cat is in proximity to notice. Or the care provider might hold their pet up in their arms, giving the cat access to reach otherwise inaccessible tiers where a fresh group of toys, not usually within reach, can be reached for batting. This invention provides a fun, interesting, ever accessible, achievable challenge for cats.

It is an object of this invention that the natural focus be drawn toward “flying” toys and aerially moving formations of these toys. Cats notice movement peripherally, and this airborne movement can be a call for their instinctively responsive action. The natural attractant cat toys, especially when in motion, provide the initial trigger for a cat's innate tendencies to pursue, and then reflexively engage with, this toy in play. This toy keeps the cat's attention through aerial-born movement of varying predictability. The enticing illusion of toys as flying objects is enhanced by accessibly locating the toy in an upper level of the room. A sense of motion in attractants being in part above and/or beyond reach of the cat, in larger form, enhances this invention. Individual toy-attractants, and the synchronized yet varied formations created by these toys in movement, are visually accentuated over the rod and supportive line structure from which they dangle. The perception of the rod's insubstantiality as compared to the more tangible presence of toys furthers a sensation of airborne creatures. A sense of an airborne creature, as well as a sense of a nest of plural creatures, is enhanced by this toy being predisposed to chaotic movement if tugged or batted. The formations of motion are altered in intensity and direction by aggressive action on the cat's part, thereby imitating behavioral characteristics of interaction with live prey. By continual variations in movement and non-movement, as well as directional changes in rotation and degrees of horizontality, this toy abstractly mimics perceived movements of a live flying creature doubled over the perception of multiple creatures. This invention provides a constructive outlet for exercising an animal's instinctual drives. Depending on the number and formation of tiers of attractant-toys used, an illusion of multiple danglers being instinctively perceived as being parts of a single animated whole, alongside the sense of multiple prey, can be emphasized to a greater or lesser degree.

It is an object of this invention that multi-faceted shapes of overall movement be present when activated. The independently suspended plurality of toys and the individual tier sections are rotatably coupled via freely moving suspension rod-to-line connections. Rods and lines are connected in a multi-axial manner, allowing for the separate rotational and individual movement course of each individual section. In an activated state, each tier moves in its own individual, random, concentric rotation while also following movement pathways within the concentric rotation of each above tier level and the entire toy from its topmost pivot point. The structure of this toy facilates multiple direction capability of individual parts and the whole. The two lowest, or accessible, tiers may overlap in occupying the same rotational area at different times, being suspended from another rotational rod immediately above them, traveling on the above rod as it carries them on its own rotational movement.

Many cats are especially intrigued by circular motion shapes, and the laterally circular rotation stage of movement takes advantage of this fascination. These circular rotations are visually attained when revolving toys settle into rhythms, whereby each end goes around and comes around again in ongoing movement. The two lower, or accessible level, tiers of suspended cat toys move in pathways which alternatingly overlap each other. These two periodically accessible tiers are kept from coinciding on the same pathway at any one time by maintaining their spacially separated suspension locations in connecting to the rod above them. Depending on number of tier levels, a visual effect of looking upward or outward into layerings of circular movement can be periodically attained. The multi-faceted motion shapes provided in this toy provide instinctive stimulus for cat action. The various formations created by motion entice awareness of and pursuit of a whole and parts of a whole, through movement of plural individual toys.

It is an intention of this invention that it provide a variety of forms of motion while one tier level of toys is attainably made contact with by the cat. This cat toy transmits active energy imposed on any one of its parts into multi-faceted movement of other parts and the whole. The various accessibility of toy-attractants is an enhancing aspect of this invention. As this mobile-structured toy moves, it brings different dangling cat toys, of both alternatingly accessible lower tiers and the inaccessible upper tiers, around in diverse pathways. When there is aggressive batting or tugging action on any dangling toy suspended from an interactively accessible tier, the entire toy is sent into intensified, erratic, spinning, and haphazard rocking motions. In a chaotic movement stage, this toy can sensorally mimic multiple motions imparted by a prey oriented animal landing in a nest of prey with plural prey scurrying toward and away from the animal, in a confusion of multiple individual movements. Intensity of initial movement, on animal interaction, comprised of chaotic or dancing rotations, varies according to the degree of aggressiveness in interaction, and there is no specific type of initiation of movement necessary to interestingly activate the toy.

With varying degrees and types of interaction, this toy reliably activates into one stage, or form of movement, or another. If the animal less aggressively bats at an attractant-toy, unpredictable motion of less intensity occurs. Initial randomness of movement created by a cat's physical interaction with this toy naturally evolves, through refinding balance, to its tiers, settling into laterally circular movement patterns. With these more rhythmic revolvings, the lower, or accessible, tier toys become, once again, a more achievable challenge for the cat to make contact with. Instinctively noting the pathways of motion of the two accessible tiers, alternatingly rotating and thus varying in reachability, a cat can reflexively target a specific attractant-toy to pursue. Additionally, if an animal tugs on and maintains their hold on an attractant-toy, they may temporarily stop the action of the toy until letting go. This letting go then causes the toy to activate anew. Some degree of chaotic or unexpected movement and twirl direction is renewed each time the cat successfully makes contact. Continued follow-up of physical interaction by the cat continually renews and revises motion of the tiers, providing for sustained interest of the animal. This invention provides a constructive and playful arena for an animal to challenge and exercise their prowess.

The enticement feature of this cat or other animal toy invention, in a preferred embodiment, is compounded by its offering a dual sense of prey. It offers a perception of prey from two perspectives, that of the individual attractant-toys, and that of the overall body comprised of a plurality of individually moving parts. Among the elemental parts of this invention, dangling toys on lower level tiers are accessible to instinctual batting. This toy conveys to a cat a sense of large and varied movement above it, parts of which are related to, but beyond the immediate reach of, what is interacted with. This freely moving mobile toy in a loosely contained, changing form can give a cat a sense of being in the midst of or in immediate proximity to a movement similar to that of instinctive quarry, of which only certain parts become alternatingly accessible.

When a bird flies, its position and the angles of its visible form change with flurries of shapes such as altering wing arrangements, shapes within the body changing form and direction, as well as its body as a whole moving through air at different angles. In this toy, motion transferred from any one part to the other parts and back again in ongoing reciprocal transfer effect instinctively triggers reflexes toward an airborne creature's essential fluidly shifting shape within contained motion. In changing form, this toy invention offers a challenge in its complexity of rhythms, motion shapes, and choice in attractant-toy to be pursued. Motion which especially draws cats' instinctual interest and action is most naturally that which has elements of unpredictability to excite them but has enough pause or regularity to periodically enable contact. These features make for accessible challenge.

Another sense of prey is provided in the multiple individual toys in motion. When this toy is aggressively tugged on, the plural prey attractant-toys swing around and move in an every which way manner of chaotic movement. This provides a sense of landing in a nest or clustered group of prey, and sending them all abruptly scurrying in confused circles and directions. This confused, multiple-aspected and unpredictable movement of plural prey is a strong enticement for instinctual pursuit and reflexive action.

It is known that cats will stalk and play with prey for periods of time. Cats often instinctively pursue playing with parts of live prey such as tails, wings or limbs and will continue with this, sometimes batting or tossing their quarry about, for as long as they sense it as alive. This invention invites a cat to exercise instincts toward batting at, playing with, or catching, a moving part of airborne prey. Similarly, live creatures caught by cats tend to continue in some movement, regularly or between pauses, through survival instincts to escape. While this toy can be brought to a brief standstill when an attractant-toy is sufficiently tugged on and held, when the toy is again let go, all elements naturally reactivate in response.

This new cat toy brings the cat into pleasurable, constructive, and satisfying relationship with instinctual and reflexive drives. It provides a multi-faceted stimulus to the cat's innate instincts through a relatively simple method and machine. It is a simply structured instrument which evolves into more complex affect. This cat toy invention is a distinctly successful solution to meeting the needs of cats, taking advantage of multi-faceted animal instincts in a playful manner.

It is an object of this invention that its continuing interest to a cat or other animal be further reinforced by the use of momentum. Freely suspended elements are sensitive to slight, moderate, or great, movement. Energy imposed by direct cat-paw contact or happenstance means, creating directional input in any part, transmits throughout the structure and leads to an accompanying self-perpetuating motion for a period of time. This toy contains structural features enhancing continued movement in individual sections translating to continued movement in the toy as a whole and vice versa.

While keeping to a theme of overall lightness in weight in all elements, a slighty greater amount of weight in the danglers can also facilitate momentum. This advantage can be furthered by the shape and distribution of weight within the toy-dangler. If an unevenly weighted toy such as a toy mouse is used, versus a ball of relatively even weight distribution, this uneven weight distribution can be used to further regulate and continue movement. As is true of a pendulum with the more weighted section being at the lower end, a regulated rhythm and force for continued movement can be enhanced. Thus, hanging attractant-toys, such as toy mice, with the direction of their body or area of greatest weight in the downmost position, in a vertically held position in which the tail extends upward and nose points downward, encourages more swing action and momentum. Simultaneous advantage to this directional position in the case of a toy mouse is, taking best advantage of pendulum-type energy characteristics, the tail being used as a continuation of the line suspension connector to rod.

In the interest of facilitating momentum, it is preferable that a directly balanced weight distribution and lateral symmetry be maintained in placement of toy elements on rods. The rods are intended to maintain an essentially horizontal, or balanced at rest, position, rather than being skewed. In a preferred embodiment using truncated horizontal rods, there are advantages to the rods having a slightly arcing horizontal shape, with the arcing resulting from the weight of suspensions at each end of such rod. This arcing, caused by slight end-weighting, encourages the rebalancing of tiers and the evolvement of laterally circular motion patterns, further enhancing momentum by helping to bring elements of the toy into more regulated patterns of movement after chaotic activation. In this toy's natural regaining of balance, evolvement into smoother, more rhythmic, continuing rotations among the individual elements and whole affords a self-perpetuating movement stage providing successful interplay opportunity for a cat.

In this toy invention, naturally self-perpetuating movement of the whole complements movement of the parts and vice versa. It takes advantage of characteristics of both pendulum action and mobile form action, utilizing these characteristics toward balance, motion transference, and motion continuation.

It is an object of this invention that in its preferred placement it be accessible to the cat by climbing or jumping to upper space surfaces in a room. Placement in an upper environmental space adds further to the sensation of being in a shared space with creatures of the air. Additionally, in this upward position, this toy displaces air rather than otherwise usable areas of space, such as ground space.

It is known that cats enjoy ascending to and positioning themselves in high places (e.g. windowsills, high shelves, lofts, trees, refrigerator tops, etc.). Additionally, cats have an instinctual drive toward and are very much aroused by flying insects, birds, dangling spiders, and other creatures of the air and will pursue them when seen. This cat toy invention is preferably placed at an upward level location in a room, to which the animal has to physically move by climbing or jumping in order to reach toward suspended attractant-toys. From this position, in a multiple-tiered embodiment, toy-attractants on a lower tier can then be reachable to bat or tug with a forepaw. Many toys provide interactive play where the cat has access to the toy from lower or ground levels within a room. While natural prey, and a cat's natural instincts, do come into play at ground level, the upper space levels of a room are a natural territory as well. This invention is preferably independently situated in an inner domicile's “sky” rather than being closely related to the floor or lower reaches. Such a placement also complements convenient use of space for human beings.

A higher surface from which a cat plays with this toy may be a previously determined favorite area, such as a windowsill. In a higher level placement, abutting any higher horizontal surface used is necessarily a wall, window framework, or other vertical surface, against which the cat can lean and then reach toward the mobile. This vertical surface allows the cat to stabilize its posture and find balance in ways natural to it. This vertical stabilizing wall is best having a corner aspect, but a simple vertical supporting wall is sufficient. From an upper level location a cat can, while using one forepaw against a vertical surface to stabilize themselves, reach out with its other paw to interact with the toy. The cat's natural instincts leads it toward making body-stabilizing use of the surrounding, existing structure when seeking out play.

It is an object of this invention that it may be sensitive to and excited by happenstance sources of energy, when available. Happenstance sources of air movement may include inherent-to-dwelling breezes caused by heating or cooling mechanisms, natural breezes entering through windows, etc. In its essentially lightweight and aerially suspended state, domestically internal air currents can trigger movement and subtly waken this toy. This aspect compounds a pet's perception or instinctual response to this toy as animate. Movement of the toy derived from happenstance air currents can act as a lure when no deliberate physical interaction has taken place.

Independently moving objects, of themselves, spur instincts in cats and many animals to notice, look closer, and to investigate whether the moving body may be an object of interest to pursue. The benefits of this toy being activated by happenstance energy are compounded in that gentle activation can also give a sense of company or animate presence, thereby comfort, to a pet who may be home alone, regardless of whether the cat pursues activity every time the toy is wakened.

It is an object of this invention that it be physically as well as mentally interactive. This toy is intended to have an appropriate level of challenge alongside providing interactive interest that is ongoing and enduring. It provides fun in varying levels of challenge. In this toy invention, these aims are accomplished simultaneously with providing instinctual pleasures for a cat by employing innate attractions and prompting instinctive reflexes.

This toy offers physical exercise in interaction through full body, hind leg, and foreleg stretching; balancing; and reflexive batting at toys; as well as exercising other muscle groups used in climbing or jumping to reach it. It calls for focused exercise of small muscle dexterity, eye/muscle/paw coordination, and reflexes, through physical interaction with dangling toys. This toy provides choice of prey to pursue, exercising both straight-ahead and peripheral vision. It provides opportunity to coordinate physical reflexes with sighted prey, entailing development or use of reflexive evaluation skills. The entertaining challenge and exercise provided by this toy are attuned to a cat's natural instincts and interests. This toy invention allows for naturally developing a cat's abilities while providing satisfying enjoyment.

The benefits of interactive play and entertainment provided by this toy include both physical and mental exercise. It instinctively inspires a prey oriented animal's involved attention. This toy provides for using some degree of reflexive problem solving through a cat's practicing their sense of timing and spatial perception in order to accomplish contact with the toys. This form of problem solving is in a form innate to cats.

In this invention, cats make reflexive choices concerning which particular prey, or dangling toy, they will pursue. This choice may be kept to a relatively simplistic level, when the momentum has slowed, by focusing on toys dangling from one rotating rod. Awareness of a higher level of challenge can evolve when a cat's focus broadens to include potential access to other periodically accessible tier level sections of suspended toys, revolving both individually and as a unit in alternatingly overlapping pathways. This aspect makes choices more involved due to the accessible dangler-toys moving in different rhythms and/or directions in relation to each other. Level of challenge is also affected by speed or intensity of movement at which the cat reflexively chooses to engage with a toy. On initial introduction of this toy, a cat may take a random approach to making contact with toy-attractants, and later develop further competency and strategizing abilities in play. The challenge is thus available to different or growing levels of ability and dexterity. This feature also enhances maintaining ongoing interest by simply providing variety.

Through the achievable challenge provided in this toy, the cat is able to practice and develop innate abilities. Through the cat making contact with dangler toys, initiating motion, repeating the actions which had brought results, and having ultimately successful experiences, all the while amid complex movements, a cat can become more aware of its competence. For a cat or kitten who does not have a sense of its own capabilities, or for a grown cat prone to fear or anxiety, this toy can naturally, through play, help it to discover its abilities and gain a sense of empowerment and confidence. This toy satisfies innate instincts while being beneficial to a cat's health and well-being in a way that is met in fun and play on the cat's part.

It is an object of this invention that varying structural methods may be used in constructing it. The visually manifested design of the invention can vary widely within its effectively carrying out its aims. Although arrangements of elements, plurality of elements, and dimensions of various elements can be adapted for its specific or preferential use, a few points should be observed for optimum design.

Structurally, this toy has an essentially open framework. It is constructed in a way that encourages free movement of all elements and suspending junctures. Structural concerns aim toward the tiers and the toy as a whole being able to move freely and fluidly. It is preferable this toy have enough physical span and size to give tiers a sense of whirling at certain stages of sustained movement. In its more fluid stages of movement, it is to carry a sense of the attractant-toys moving through air in varying pathways, at varying speeds, and promoting momentum, rather than having a jiggling-type of characteristic as a centrally-noted movement. Certain embodiments may include a means of adjusting balance through positioning adaptive weight or changing length of suspension line, though this is an unnecessarily complicating feature in the preferred embodiment.

It may or may not contain an extremely low degree of spring action enhancing initial bounce as part of the uppermost, adjustable length suspension line supporting the toy's attachment to a dwelling. However, spring action may lessen the more freely moving characteristics of this animal toy to some extent, accentuating the chaotic movements beyond what might be desired or inhibiting momentum, and is therefore acceptable but may not be preferable in all embodiments.

Vertical spacing between tiers, achieved through length of suspending connector lines, keeps in mind warding off any tangles which might occur through temporary diagonal angles of rods created by an attractant-toy being tugged on and the consequent chaotic motion of tiers. Tier rod sections aligned on the same lateral plane should not overlap when at rest. These sections, inclusive of danglers, have a wider area of circumferential movement when motion is activated. For example, lower interactive tiers seen in the preferred embodiment, which share a lateral plane, are located with enough space between them to not become enmeshed in tangles while in movement. Tier sections and danglers may be of varying structural numbers and arrangement, keeping in mind preserving balance as well as facilitation of various movement types, rhythms, momentum and playful challenge.

Rods may be shorter or longer while having a quality of perceived thinness. Rod length is flexible, though in an embodiment of toy invention specifically for domestic cats, rods may be preferred to be in the range of 6 inches to 20 inches. The longer the rod length, the more movement and sweep of space, and the more activated sense of presence can be created. The number of rods used may vary. Cylindrical rods or other aerodynamically-enhancing and strength-concentrated shapes are preferred over squared rod shapes. Flattened rod shapes may be used if kept lightweight, visually unobtrusive, and positioned with the flat side providing a surface complementary to picking up air currents, enhancing motions of the beam, etc. It is preferred rods be positioned essentially horizontally or only slightly tilting while at rest. This horizontal characteristic to the rods may be complemented by a degree of arcing caused by the weight of attractant-toys at rod ends. Arcing or slight variations on direct horizontality of rods is made to be essentially symmetrical when at rest. Variations in rod structure are acceptable as long as the basic balance, characteristics which facilitate movement and rhythm, and lesser perceived presence as compared to toy-attractants, are kept true to.

Connecting lines between tiers may be run through holes in rods and then knotted and/or otherwise secured at connection points. In an alternate method of affixing line to rod, suspension lines may be wrapped around the rod and reaffirmed in being securely located by notches in the rod, plastic coating, and/or other means staying true to the spirit of this invention. Swivels or other means may be used to assist motion in affixed suspension lines.

The number of attractant-toys used may vary. While animal-attractant toys may be dangled in various positions, there are advantages to hanging unevenly weighted toys with their greatest weight in the lowest position. Suspension lines for dangling mice attractant-toys may or may not be combined with and lengthened by use of tail extensions as part of a unified suspension device. A consideration, if using a tail as part of a dangling connector line, is preserving dangling action; this can be realized by combining the tail extension with the dangling connector line, unifying the two materials by threading the line through the tail, or other by other appropriate method. In this embodiment of toy-dangler construction, the dangler line is threaded through or otherwise affixed in a secure way allowing for free motion. The length of dangler line is best determined by amount of swing the attractant-toy's pendulum weight affords, safety from strangling potential, avoidance of tangling, efficient balancing of the rod, and aesthetic sense. Fine tune balancing may also be accomplished by adjusting suspension line length, end of rod weighting while the toy is in suspended position through use of hot glue dabs, metallic tape wrapped on ends, or other appropriate method.

Any variations on the basic structure need be taken with the aim of holding true to the essential nature, spirit and aims of this kinetic cat toy.

It is an object of this invention that it may be made of varying materials. Suspension line connectors between rods may be monofilament line, string, cord, fishing line, or other appropriate material not prone to snapping off or easy breakage. For safety reasons, common elastic cord is not a preferred material for suspension line connectors. Additionally, the pronounced bounce provided by common elastic of any substantive length may add an undesirable extreme of chaotic motion, potentially tangling the tiers.

Rods may be made of spring steel or other metal, plastic, wood, or other lightweight material. Light reflective materials, such as metallic materials, on or near the ends of rods or located on rods near the toy-attractant suspension connections can enhance the sense of aerial movement. When in movement, certain metallic materials may catch the light in a flickering way, which both furthers the spirit of this toy as well as providing a sparkle feature which can be a cat attractant.

Type of dangler toys used may vary. Target toys may include any cat-interactive attractants of appropriate size, weight, and commonsense characteristics. Toy-attractants may include toy mice with sturdy or reinforced tail connections, weighted or unweighted feathers, toy birds, cat toy balls, luminously treated toys or toys that light upon impact for the nocturnal cat, crinkle balls, glitter balls, fishing lures sans hooks or other dangerous parts, and/or toys composed of fur, suede, sisal or sheepskin, combinations of the aforementioned, etc. Toys used may have harder shell innards or exteriors, providing complementary characteristics to the aims of this toy when batted at. Alternatively, toy-attractants with softer bodies are more easily receiving of claws, thereby complementing their tuggability. The use of textured toys, thoughtfully chosen with cat preferences in mind, can enhance sparking feline instincts. Using like toy elements at rod ends of individual tier levels can facilitate efficient balancing.

Additionally, other sensory features may be used to augment the affects of this toy. Catnip can be used in or on toys as an additional attractant. Cat toy crinkle balls have the additional feature of making a gently percussive sound when batted or if colliding with each other. If desirable, bells may be used. Auditory prey sounds, such as mice peeps or bird chirps, activating either independently or by interactive contact, could be utilized. The use of sound chips would, however, add to the expense of this toy, the weight of this toy, and be less environmentally friendly in the long run, necessarily enjoining with more involved technology.

In constructing this toy, balance, weight, instinctual attractants, and encouraging movement are kept ever in mind concerning use of materials. Much flexibility in choice of materials exists within staying true to the spirit of this toy invention.

It is an object of this cat toy invention that it may be convenient to use in various types and sizes of dwellings. This invention addresses certain practical needs of human caregivers as well as the welfare of their animals. This invention is particularly well suited to broad ranges of dwelling types. Its convenience to any dwelling can, however, especially answer the needs of small apartment dwellers having limited living space. It provides an unusually involving and active toy easily accommodatable to small interior spaces. With its preferred embodiment involving no use of floor or lower level space, this toy easily fits into and complements any indoor space, from an efficiency apartment to a large spacious room. In the preferred embodiment, where it is hung from a ceiling hook, this form of minimal installation is a common and acceptable alteration to structure for both renters and owners. This aspect of placement is doubly successful in that it also meets with cat's instincts and pleasure in climbing and being at higher levels.

Preferred location of installation for this toy provides for it being categorically less prone to getting in the way of daily activities occuring in the cat's shared environment with caregivers. Its suspended form is preferably not located where it would cause interference or inconvenience for cat caregivers. It need take up no floor space which might otherwise be used for other purposes, or where it might come in contact with the lower legs of humans. Preferred installation location for this toy displaces what is typically unused space. This cat toy does not add a sensation of crowding because of its intrinsically airy quality.

This interactive cat toy can be an agreeable addition for cat caregivers. Human beings often take pleasure in the presence of subtle and harmonious movement. This animal toy neither excludes nor encloses space in its workings, moving freely within space. It can be entertaining and soothing to human spectators as well as their animals. Its rhythmic and aerial movement enhances the general ambience of an environment, and when highly activated by pets in the caretaker's presence, it can bring joy through observing the cat's pleasure and well-being while in play. In its preferred embodiment, if played with by the cat nocturnally, within the range of caretaker's hearing while sleeping, it is an auditorially unobtrusive toy.

This interactive toy can also be adapted for use in outdoor cages for cats or other animals. Additionally, it can be adapted in size, sturdiness, and materials used, to improve the quality of life for confined wild animals. This sort of embodiment could make use of upper cage space accessible from the bunks typically present in tiger and other large cat cages. This toy invention is adaptable to use with other animals as long as it maintains aerial placement, free movement, answers a particular animal's specific instincts, is safely constructed, and follows through in qualities consistent to the basic spirit as stated.

It is an object of this cat toy invention that it be installed in a semi-permanent placement. This toy necessitates minimal installation and is easily moveable. In a preferred embodiment, its installation is no more involved than hanging a picture. It can be aerially suspended using a hook in the ceiling, a beam, or like surface. When hung from a ceiling hook, as in the preferred embodiment, this toy is in its most aerially free and true spirited embodiment. It may also be hung from a bracket extending from a wall, or from a diagonally abutted horizontal rod attached to walls in a corner area, or by other appropriate method. Either the bracket method or diagonally placed rod method take up a minimal amount of wall space and can be located at a height where a cat need ascend to reach the toy.

The length adjustment aspect in the connector line atop the toy allows for semi-permanent adaptions in height, providing a stabilized height for the toy as a whole and, therefore, the height at which the lower tier rests for reachability by a cat. In one embodiment, the uppermost suspension line which is connected to a hook in the ceiling may be made of extended loops, allowing any unneeded remainder length of loopings to be cut off after determining the length needed. If the extended loop method were used, loops need be of a small enough size to pose no strangling danger. Another potential embodiment of the uppermost suspension line which connects to a hook may be a connector device such as a toggle or catch device (for example, those used with sleeping bag cords or children's shoe laces) whereby the line could be easily adjusted in length. Yet another embodiment of this height-adjustable suspension line includes a length of suspending line to be tied on a ring, with excess cut off once needed length is determined. This topmost connector line is flexible in structuring, necessitating only that it be adjustable in length, freely moving, and in fitting with the spirit of the invention.

When considering accessibility from upper areas, this toy is to be hung where the cat's paw reach, in relation to the lower tier toys, is in appropriately close proximity to a wall or supporting vertical surface, but allowing enough distance between the toy and the wall to allow the toy free movement. The separational space needed between toy and wall can be little more than the defining circumference of space used by the toy in movement. It is well accommodated to a position where the animal stands on their feet and stretches upward toward it, the height at which it is hung being adjusted to where the cat's paw could only reach the lowest tier toys from this position.

When accessible from upper space areas, beyond being placed in immediate proximity to horizontal and vertical support surfaces needed by the cat, allowing enough circumferential space for the mobile toy in movement, and being in a location where the cat can jump or climb to reach it, this toy has flexible placement. Cats enjoy looking out and being in proximity to windows. The optimal placement for this toy may be a favorite window spot of the cat. A window area placement can also further accentuate an extended sense of air and nature in the immediate area. Regardless of environmental location, it is best placed in location where, when playing, the animal can have sense of motion above them and peripherally, while being in a familiar area pleasing to them.

It is an object of this invention that it be made in a way thoughtful of the safety of cats or like animals as well as those they share a living space with. The ends of the rods are protected from being potential pokers by use of plastic bumpers, ball bumpers, feathers, or softening by some other means. If metal rods are used, one method of softening their ends is bending them back on themselves creating small end circles thereby blunting end points. Any small parts, such as mice eyes or bumpers, are securely affixed to prevent their disengaging, thus avoiding potential danger of small parts being swallowed by pets or small children. If a rod is somehow walked into, the toy's inherent dynamic causes its tiers to naturally shift position. If using mice as dangling attractants, hanging them in a body-downward position has safety advantages as well as complementing momentum. Through use of the tail as part of the dangling suspension line, less length is required in the thin support line, further reaffirming avoidance of any potential strangling danger. If common forms of elastic cord are used in any suspension line, substantial length is preferably not used due to the enhanced strangling danger posed by this material. This toy contains no electrical connections which might provide concern for chewing of an electrical cord or potential for fire. With this toy invention's placement in the upper reaches of a room, it cannot be tripped over or fallen on.

Preferred placement of this toy in higher room levels necessitates directives for the cat's ease and safety. Necessary thoughts include identifying where the cat can maintain balance in a posture natural to it for interaction. It is to be located near a vertical surface or vertical corner where the cat can exercise vertical balance as well as be solidly supported while in a standing position. The horizontal standing area should not be slippery, as would be marble or formica, or flexible, as is a cat-hammock window seat. Horizontal surfaces composed of painted or unpainted wood, an inner-hardshell cat window seat, fabric-covered surface, a surface of naturally-adhering rubber waffle-weave shelf-lining material, or carpeted covering as seen in cat furniture, etc. are commonplace and suitable. If installed near a window in an upper-story of a building, common-sense safety should be considered in direction of play being clearly aimed toward the interior and the window being closed or securely screened.

It is an object of this invention that it may be durable. The structural stresses of movement created by a cat batting at dangling toys, as well as the diagonal pulling forces created when a toy is caught and tugged on, make necessary a durable and reliable construction. The suspension line connectors need be resistant to snapping or breaking under stress. One method of reassuring durability at junctures of elements, especially at the tier which is immediately interacted with, is by use of plastic-coating at connection points. Another method can include fusing of end-knots or using glue-gun spotting at knotted line juncture points. Use of plastic or glue at juncture points is done in a way preserving the line's free play in motion. Notching of rods where line is located may also be used to maintain a stable, positioned relationship between line and rod, especially if the line is wrapped around rather than run through the rod. If mice-toy danglers are used, hung in part by their tail with the body downward, a strong tail-to-body connection is required to assure the tail and body stay connected when attractant-toy is tugged on. The sturdiness of a tail-to-body connection may be further affirmed by continuing the suspending line through the tail as well as the body of the toy. Another method of reassuring tail-to-body connection is that the toy be assembled with the exterior covering of fur or other material being of one piece rather than assembled parts. This cat toy invention necessarily requires a sturdiness, especially in lower tier level interactive toy danglers, that can resiliently stand up to its being an interactive toy of enduring and keen interest.

It is an object of this invention that after being placed in its setting it necessitates no further use of energy sources such as those provided by technology (e.g. electricity, computer chips, batteries, wind-up, or other technologically superimposed means). This is a simple machine which is set in motion by the interactive animal, happenstance air flow, or human care provider. This toy is enhanced by self-perpetuating motion facilitated through its structural form. Beyond technologically supplied resources used in the manufacture of this toy, it requires no further use of complex supportive energies or mechanisms for achieving its purpose and use. This cat toy intrinsically and effectively delivers a high degree of intriguing motion and action meeting a cat's instinctive callings for interaction. Its ever available, simple, and inherently responsive complex motion is an advantage to perking and maintaining a cat's interest when home alone, as compared to needing to be turned on, activated or plugged in. In addition to its environmentally favorable characteristics in ongoing use, it is not toxically or otherwise notably harmful to the broader environment at whatever future point it may be recycled into parts or disposed of.

It is an object of this invention that it be well suited to efficient manufacture and marketing. This toy may be easily and efficiently manufactured and marketed with resources already existent to many related-field companies. Methods and materials already used (e.g. in caretaker-interactive cat toy wand, suspended cat toys, etc.) could relatively easily be adapted to the manufacturing of this toy. This cat toy invention would, therefore, be relatively inexpensive to realize in marketable form, both in upstart and ongoing manufacture.

While this cat toy is three-dimensional when installed, it is easily collapsible for packaging purposes. It can be packaged in a flattened, then folded, manner where suspension lines are kept from tangling. One method of efficient packaging includes laying out the mobile on a one-dimensional piece of paper or plastic, with all rods positioned parallel to each other, then taping, stapling, or otherwise temporarily affixing in several areas to prevent unsettling movement or tangling during shipping. This stabilized and positioned flat arrangement of the preferred embodiments of this cat toy can then be rolled or folded and placed in a relatively narrow package. The length of the packaging container is determined by the length of the interiorly folded containment of rods. It can then be easily removed on purchase by unrolling, removing tape, and lifting out, thereby restoring it to its extended three-dimensional shape for suspension. A ceiling hook would best be included in the package so that all parts necessary for use of this toy would be readily available for easy installation. Pictures of a cat in interactive play with the toy would necessarily be featured on the package, in obvious placement for purchaser viewing, as the spirit of, special features, and purpose of the cat toy would not otherwise be evident in its packaged state. Simple directions for installation and advantageous placement would also be necessarily included.

Shipping this cat toy would be economical in that it would involve transport of a lightweight item taking up a minimal amount of space in its folded state. Advantages for transport translate into advantages for efficient and flexible accommodation to shelf space in stores. This toy invention could be either stacked on a shelf with picture displayed or, if the packaging provided a tab containing a hole at one end, it could be hung vertically from hooks. Optimally, an actual example would be hung in a display; this might again involve use of typically unused space in a store. Both of the above stated shelving methods are common where pet toys are displayed and purchased.

In part because of lower-range manufacturing and marketing costs, this cat toy can be made economically available to cat caregivers of varied income ranges. It is an especial advantage to make accessible an involving and very active, while space saving, toy to caring cat caregivers of lower income ranges. Alongside this particular advantage, it is an attractive toy for any household. Additionally, this already-assembled toy involves minimal effort on the cat caregiver's part to provide their cat with a very different, effective, and unusually involving toy. It need only have a hook installed, be removed from its packaging, and hung from the hook. Through providing such economically affordable availability, the number of cats who might enjoy and benefit from this toy is enhanced.

### DETAILED DESCRIPTION OF A PRESENTLY PREFERRED EMBODIMENT AND BEST MODE NOW CONTEMPLATED FOR CARRYING OUT THE INVENTION

Numbers used repeatedly in diagrams refer to repeated instances of a single component. Numbers having similar two digit endings (Invention 10 in FIG. 1, Invention 710 is FIG. 7) refer to similar parts of differing embodiments.

The more important features of the invention have been outlined. Before explaining at least one embodiment of the invention, in detail, it is to be understood that the invention is not limited in its application to the details of construction or to the arrangement of the components set forth in descriptions or illustrations of the present embodiment. Lengths of rods, numbers of rods and toys, and other details given are intended to provide a working example only, and are flexibly adjusted to other embodiments. It is to be understood that various changes and modifications may be made thereto without departing from the spirit of the invention. The present example of preferred embodiment FIGS. 1, 2, 3 is catered dimensionally and in other details toward domestic cats, and is not limited to these specifics for use of either cats or other prey oriented animals. The scope of the invention is to be understood from the appended claims.

Interactive, as used herein, refers to the fact that the toy will respond to the actions of the cat. Thus, the cat does not just bat, touch, claw, brush, move, or otherwise physically interact with a single toy but rather bats, etc., a first toy or beam, thus causing dynamically linked motions of other beams and toys, singly or in groups. This simulates flocking behavior of prey animals such as birds or mice. Such dynamically linked motions may occur with a full six degrees of freedom in roll, pitch, yaw and three dimensions.

The best embodiment of this invention 10 presently contemplated, as seen in FIGS. 1, 2, and 3, involves a symmetrically well balanced (that is, balanced either by weight, by distance, and/or visually balanced) indoor aerial system of tiers 20, 21, 22 composed of essentially horizontal beams/rods 31, 32, 33. The term beam (or synonym rod) used herein refers to any generally elongate body capable of carrying modest torque, stress and strain. These rods 31, 32, 33 may be slightly arcuate due to the weight of other suspended tiers 32, 33 and attractant-toys 54. All support means 40, 41, 42, 50, 51, 52, 53 may be freely pivoting, with the upper rod tiers 20, 21 connections 65 from which vertical suspension lines 41, 42 are run downward, and the rod tiers 21, 22 to which these suspension lines 41, 42 connect below, allowing for independent action in movement. It will be seen that the device comprises a plurality of vertically sequential tiers, one above another. The tiers may be somewhat horizontally offset, and more than one beam may comprise a single tier. Each tier of beams or some portion of the beams may have suspended therefrom cat toys/attractants and additional tiers and additional beams.

In the preferred embodiment, all elements of the invention 10 are aimed toward enhancing sensitivity to movement and are thus of light weight. During assembly, attention is given to rods 31, 32, 33, junctures 65, and suspensions 40, 41, 42, 50, 51, 52, 53, 54 in the interest of supporting fluid movement and balance in structuring.

A suspension device such as a ceiling hook, wall hook, eye-hole screw, bracket, suction cup, combinations thereof, etc., may be employed to suspend the invention from a structure such as a house interior or exterior, a wall, a tree, furniture, a door, etc. This suspension creates a primary axis suspending the remainder of the cat toy. Suspension of the tiers may be accomplished by the monofilament line discussed, or by strips of fabric, strings, wires, chains and combinations thereof. It is desirable that such suspension members as these are strong enough to resist breaking by a prey animal using the cat toy.

The structural outline of tiers 20, 21, 22 includes an upper tier 20 dangling from a centrally placed connection point from the uppermost supportive line 40, this uppermost supportive line 40 being composed, in its upper end, of loops by which it connects with and hangs from a ceiling hook 12.

The uppermost rod 31 has a suspension line 41 running downward from its center by which it connects with the center of parallel second-down rod 32, this supporting knotted connection 63 on the below rod 32 also being made in this lower rod's 32 center. This uppermost rod 31 has an attractant-toy 54 dangling from each end, which toys are suspended in small length by dangling suspension line 50.

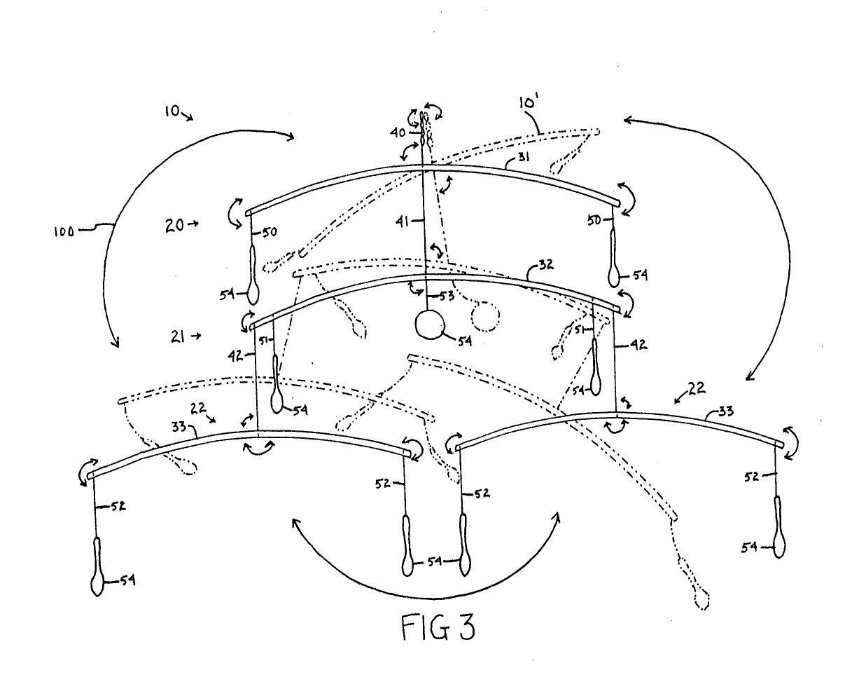

This second-down rod 32 contains two line suspensions 42, one from each end, essentially symmetrical in length and placement, each of which attaches to the center of a shorter rod 33 suspended below. Also suspended from the second-down rod 32, in-set from each end at a slight distance from the downwardly suspended connecting rod lines 42, are suspension lines 51 and suspended cat toys 54. Additionally, a cat toy 54 is dangling suspended from the center of this second-down tier rod 32, such as light-catching glittery fibrous ball 54, with this centrally suspended toy being on a suspension line 53 of comparatively lesser length. This comparatively lesser length of suspension line 53 is of shorter length to prevent interference of line 53 or attractant/glittery fibrous ball/mouse/toy 54 with the ends of lower tier rods 33 when they are in motion or if cat tugging causes them to become diagonally directed, as illustrated in FIG. 3. Shown in phantom lines, invention 10′ is in dynamic response to some physical contact by a cat or human. Dynamic motions (which are governed kinetically according to well known physical principals of motion) are illustrated by arrow 100, which illustrates on of the six degrees of motion afforded to each part of the cat toy. As the various parts are connected, these motions are linked to one another. At this point of description, the visual composition of the two tier rods 20, 21 is of their being centrally connected, one above the other, in an essentially parallel relationship when in stasis, in unpredictable relationship during motion.

The third-down tier 22 is composed of two rods 33, aligned end-to-end, supported from their centers by lines 42 running from the second-down rod's 32 ends. These two lowest rods 33 are at the level of accessibility for animal 90 interaction. In placement width, being connected at their centers to the above rod's 32 ends, each of these lowest rods 33 extends beyond the outermost end of the rods 31, 32 above it. Visually, these lowest rods 33 create an extended implied line, with a gapped center. This implied line of rods 33, in an essentially horizontal pre-arced state, is parallel in relation to the above pre-arced rods 31, 32. These third-down rods 33 are individually of slightly shorter length as compared to the above rods 31, 32, allowing for this small space between them, rather than meeting end-to-end as if in a physically-manifested continuing line. This gap between the two rods of the third-down tier 22 is necessary in avoiding their conflicting or tangling when the toy is in intensified motion as seen in FIGS. 1 and 3. The two lowest tier rods 33 are symmetrically balanced in placement and in additions of suspended toys 54 within each rod 33, as well as each rod 33 being symmetrically balanced to the other. The lower rods 33 are essentially mirror images of each other, with each having a dangling toy mouse 54 suspended from both rod 33 ends. The dangling toy mice 54 are suspended 52 in part by their tails, with the lower and heavier body parts in the lowermost position, where it appears each mouse is looking down and the cat will be in closest contact with the face of the mouse 54 rather than other body sections. Thus is the basic formational arrangement of the invention 10.

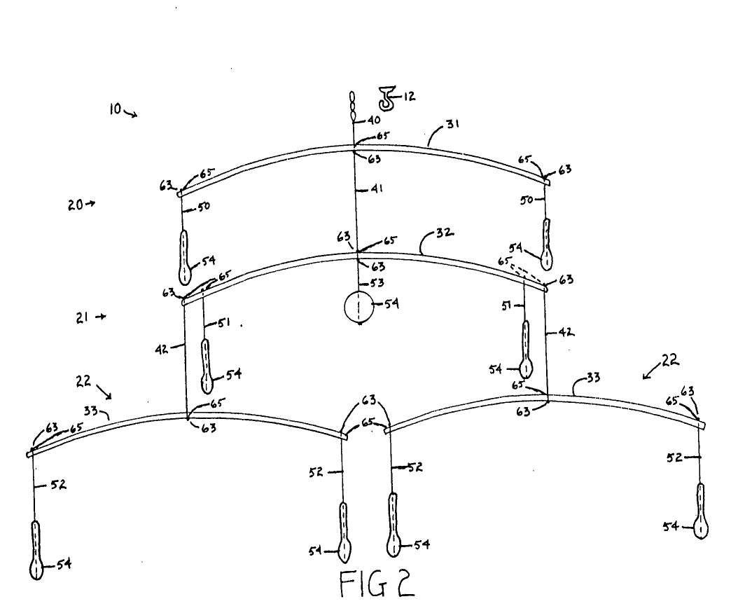

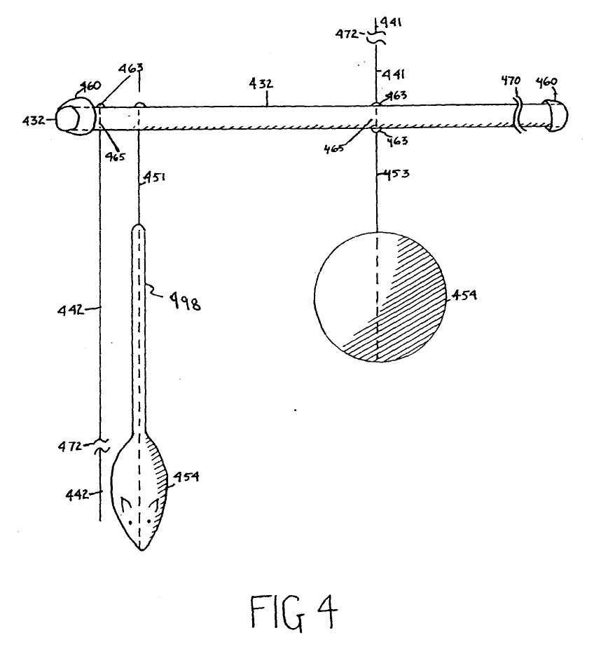

Assembly can be accomplished by first connecting all rods 31, 32, 33 and connector suspension lines 40, 41, 42, working from the top down, or from the bottom up. In the presently preferred embodiment and best mode now contemplated for carrying out the invention (based upon experimental testing) it has been found that connecting the dangling/suspended attractants to the beams first prior to connecting the beams to each other is more efficient. After this basic structural assembly, again working from the top down, the toy danglers, already assembled with suspension lines 50, 51, 52, 53 (450, 451, 452, 453) having been run through the toys 54 (454), are added, as illustrated in FIG. 4, during which any fine tuning to balancing can be accomplished. When assembly is completed, having had the aim of horizontal placement of rods 31, 32, 33, a slight degree of slanting in these rods is acceptable, providing it does not interfere with the essential twirling and momentum as seen in FIGS. 1 and 3, and overall balance as seen in FIG. 2.

The rods 31, 32, 33 are caused to be gently arcing by the slight downward weight of toy-attractants 54 as well as end of rod suspensions 42 to other tiers 33. This slight arcing of the rods enhances a balanced momentum as well as giving a by-product benefit of producing more visually graceful lines. In the presently illustrated embodiment, the top 31 and second-down 32 rods are 18 inches in length, while the two lowest tier rods 33 which share the same tier level 22 are each 15 inches long.

The support lines 40, 41, 42, 50, 51, 52, 53 (441, 442, 451, 453 of FIG. 4) are kept as invisible as possible through the use of monofilament line. These lines 40, 41, 42, 50, 51, 52, 53 (441, 442, 451, 453 of FIG. 4) run through 465 beams/rods 31, 32, 33 (432) and toys 54 (454) they serve to connect and are securely affixed 63 (463) at line ends, as detailed in FIG. 4. At supportive points of the monofilament line connection a knot 463 is tied to secure the position. This knot 463 (63 of FIGS. 2 and 3) may then be fused by use of heat to prevent unraveling. The monofilament line 441 connecting the top-level rod 31 to the second-level rod 32 (432 of FIG. 4) is approximately 4½ inches in length. The monofilament lines 42 (442) connecting the second-level rod 32 to the third-down rods 33 are approximately 6½ inches in length, in the presently illustrated embodiment.

Additionally in this embodiment, the monofilament lines 50, 51 (450, 451) dangling attractant-toys 54 (454 of FIG. 4)) from the upper and middle tiers 20, 21 are of approximately 3 inches in length where dangling an iridescent ball or other tailless attractant-toy 54, or 1¾ inches in length where threaded through a toy mouse (54 and 454) tail portion (498) FIGS. 2 and 4. The monofilament lines 52 dangling attractant-toys 54 on the lower interactive tiers 22, have a length of approximately 2½ inches between rod 33 and end-of-tail on mouse 54, and the line continues threaded through the tail 498 and body of mouse/toy 54, 454 to further solidify the connection, as illustrated in FIG. 4.

Suspension members may pass through beams, be glued to beams by adhesive, wrap around the beams, connect at hooks, swivels, and combinations thereof. The beams may sport end bumpers at one or more ends, covering wholly or partly the beam ends. This is for safety, to protect nearby wall paint, pictures, etc, and to provide an additional cat attractor at the beam ends. Thus the end bumper may be any form of cat attractor/toy as discussed herein. A beam coating such as plastic may cover at least a portion of the beams, for similar reasons.

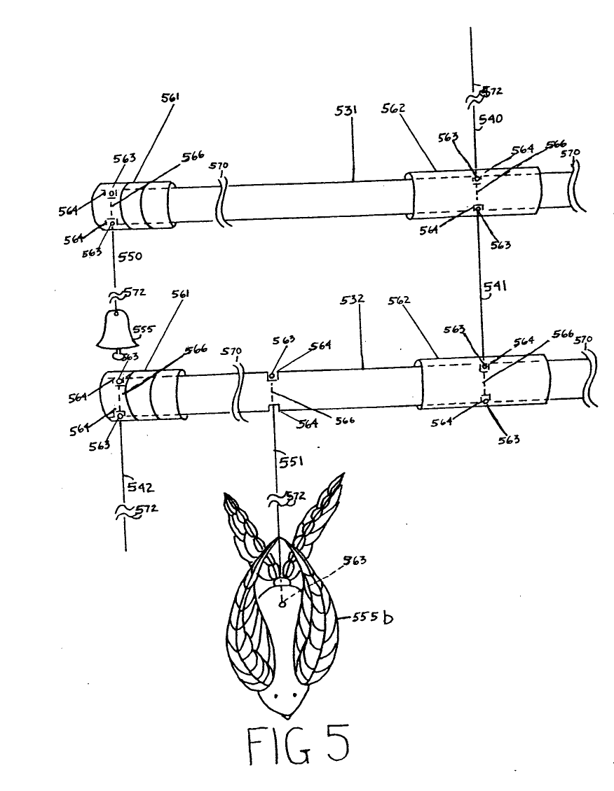

In the presently illustrated embodiment seen in FIGS. 1-3, visual focus is naturally drawn toward an illusion of toys 54 being suspended in or flying through air. To this aim, the rods 31, 32, 33 are kept as visually invisible as possible through thinness and/or coloration or transparency of material. The ends of rods 31, 32, 33 may be protected and bumpered by lightweight reflective material 61 as illustrated in FIG. 5 or fitted ball bumpers 460 as illustrated in FIG. 4. As shown, the cat may be required to climb another object such as furniture or a window sill in order to play with the cat toy. The height of suspension may be such that the animal may reach the attractants of the bottom tier when the toy is not in motion, this aids the initiation of play activity by the cat, without human intervention.

In the presently preferred embodiment, the mouse toys 54 used are similar to the commonly seen short-haired furry mice which cats are known to be fond of, but with exterior fur of tails and bodies cut of one piece as seen in FIG. 4, or tail/body junctures reassured, to be stress resistant at the connecting point between tail and body. The dangling mouse toys 54 are hung in a bottom heavy vertical position where the faces are in the lowest position, and the length of the tail 498 is used as a part of the suspension line system 450, 451, 452, as illustrated in FIG. 4.

As seen in FIG. 1, this embodiment 10 is installed 12, 40 in a corner area adjacent to a horizontally and vertically supportive window frame 81 or other highly placed area where the cat 90 or other animal and its caregivers tend to spend time. It is attached to the dwelling structure by means of a hook 12 in the ceiling. It is hung so that the interactive tier level of toys 22 is suspended approximately 30 inches above the horizontal surface 81 on which the cat 90 stands to reach it, or wherever the point is where the individual cat's 90 or other animal's paw can reach the toy from a standing position with extended foreleg, but is not able to reach the above the tier rod 33 from which the interactive toys 54 are suspended when either rod 33 is at rest. Motion of the toy is illustrated in FIGS. 1 and 3.

Some examples of alternative details in embodiment are illustrated in FIG. 5, including plastic-coating 562 line 540, 541 and rod 531, 532 connections; metallic-wrapped bumper endings on rods 561; various attractant-toys 555, 555b connected at uppermost position of attractant-toy 555, 555b of the body, with or without capping at connection point; supportive line 540, 541, 550, 552 being wrapped 566 around rods 531, 532 as connection method; and notching 564 of rods 531, 532 as method of reassuring stabilized location of suspension lines 540, 541, 542, 550. Examples of attractants/toys include spoons, feathers, fabric strips, balls, metal disks, simulated birds, bells, reflective objects, simulated solitary prey, simulated group prey, lights, hookless fishing lures, and combinations thereof. Other objects intriguing to cats may be used.

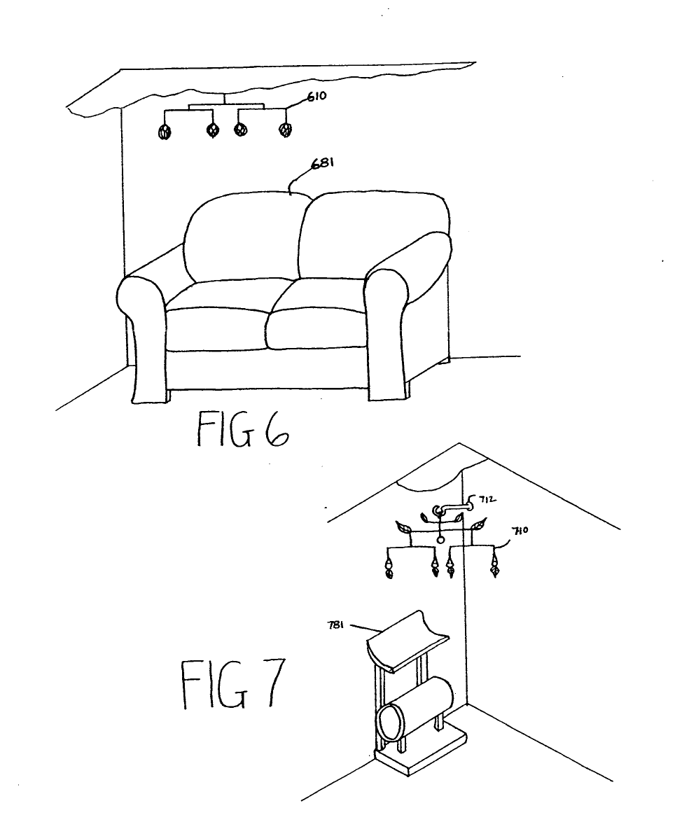

FIGS. 6 and 7 illustrate alternatively structured, located and installed embodiments of toy invention 610. In FIG. 6, the embodiment has two tiers, the upper tier free of attractants, and is suspended over a sofa 681 rather than a window sill 81 of FIG. 1. Alternative embodiment 710 of FIG. 7 has tiers of differing length and attractants and bumpers of different types, as well as being suspended over a piece of cat furniture 781 and depending from a large wall mounted hook 712.

Variations in the details of construction of and materials used in this invention, as defined by description and illustration here and elsewhere in this document, may be resorted to without departing from the true spirit and scope of the invention.

What is claimed is:

1. An interactive toy for cats comprising:
a plurality of vertically sequential tiers, each tier having at least one beam, the beam being substantially horizontal;
each beam of the tiers above the lowest tier having suspended therefrom at least one member selected from the group consisting of: cat attractants, beams and combinations thereof; wherein
each of the beams of the lowest tier having suspended therefrom a plurality of cat attractants; whereby
contact with one cat attractant causes dynamically linked motions of the beams and the other cat attractants, and contact with one beam causes dynamically linked motions of the beams and other cat attractants.

2. The cat toy of claim 1, wherein the cat attractants are in visual proximity to each other.

3. The cat toy of claim 1, wherein the cat attractants further comprise simulated prey suspended at least in part by their tails.

4. The cat toy of claim 1, wherein at least one cat attractant further comprises one member selected from the group consisting of:
spoons, feathers, fabric strips, balls, metal disks, simulated birds, bells, reflective objects, simulated solitary prey, simulated group prey, lights, hookless fishing lures, and combinations thereof.

5. The cat toy of claim 1, further comprising:
suspension means for suspending the cat toy from above, the topmost tier being suspended therefrom.

6. The cat toy of claim 1, further comprising:
a suspension device, the topmost tier being suspended from the suspension device.

7. The cat toy of claim 6, wherein the suspension device further comprises one member selected from the group consisting of: a hook, an eye-hole screw, a bracket and combinations thereof.

8. The cat toy of claim 1, wherein
suspension of the tiers is accomplished by means of one member selected from the group consisting of: strips of fabric, monofilament lines, strings, wires, chains and combinations thereof;
wherein such suspension members are strong enough to resist breaking by a prey animal using the cat toy.

9. The cat toy of claim 1, wherein the beams further comprise at least one small notch, and further wherein at least one suspension member wraps around at least one beam at the small notch.

10. The cat toy of claim 1, wherein the suspension members are secured to the beams by means of one member selected from the group consisting of: adhesive, passing through the beams, wrapping around the beams, hooks, swivels, and combinations thereof.

11. The cat toy of claim 1, further comprising:
at least one beam end bumper covering a first end of a first beam.

12. The cat toy of claim 1, wherein the beam end bumper further comprises a cat attractant.

13. The cat toy of claim 1, further comprising:
beam coating covering at least a portion of the beams.

14. The cat toy of claim 1, wherein the cat toy is suspended substantially above a climbing object suitable for climbing by a prey animal, at a height requiring the prey animal to climb the object in order to play with the cat toy.

15. The cat toy of claim 1, wherein the cat toy is suspended at a height such that the prey animal may reach the cat attractants suspended from the bottom tier when the cat toy is not in motion.

16. An interactive toy for cats, the cat toy being rotatably suspended, the cat toy comprising:
a first tier comprising a first beam, the first beam having suspended therefrom at least one additional beam;
at least one beam having suspended and balanced therefrom a plurality of suspended cat attractants, wherein
the cat attractants are in visual proximity to each other, whereby dynamically linked responsive motions of the tiers are provided.

17. An improved interactive cat toy, of the suspended type, wherein the improvement comprises:
multiple tiers at different levels;
a primary axis at the highest tier suspending the remainder of the interactive cat toy; and
a multiplicity of cat attractants suspended symmetrically by weight about the axis of suspension and suspended in vertically layered tiers;
whereby, a multiplicity of cat attractants are suspended in dynamic linkage with one another in order to simulate flocking behavior of prey.
